(19) United States
(12) Patent Application Publication
(10) Pub. No.: US 2003/0219007 A1
(43) Pub. Date: Nov. 27, 2003

(54) Reusable multi-protocol meta-architecture for Voice-over-IP playback

(76) Inventors: Craig Barrack, Irvine, CA (US); James Yik, Mission Viejo, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/154,245

(22) Filed: May 23, 2002

(51) Int. Cl. H04L 12/66

(52) U.S. Cl. 370/352; 370/495

(57) ABSTRACT

A packet based real-time data receiver comprising a protocol specific plug-in and a generic playback engine. The protocol specific plug-in receives a packet, parses the packet, generates a timestamp, and forwards the packet to the generic playback engine. The playback engine determining the playback time based on the timestamp, and for playing back the packet at the appropriate time. Any kind of packet may be processed by merely changing the protocol specific plug-in.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A “MICROFICHE APPENDIX”

Not applicable.

### BACKGROUND OF THE INVENTION

With the growing emphasis on convergence in the semiconductor industry, new products must be able to transport information from any interface to any other interface, convert from any information format to another, and provide new services and technologies as they are introduced. the capability of transmitting voice over a packet network is a hallmark of the convergence revolution. In Voice-over-IP (VoIP), the analog voice source is digitized and quantized into samples, and these samples are packed together into payload units. A header is affixed to each payload unit, and the resulting packet is sent over a network to its destination. In addition to containing lower layer fields such as routing information for the packet, the packet header must also contain reordering and re-timing information that can be used by the destination to play out the audio samples for that packet, and all packets of the same voice call, correctly and without distortion.

One problem is that in this new convergent arena, there may be many different approaches to conveying essentially the same information about a VoIP payload. The Real-Time Transport Protocol (RTP) documented in RFC 1889, provides a set of end-to-end functions suitable for transmitting voice payloads over an IP network. The RTP header format defines among other things a 32-bit-source identifier, a 7-bit payload type, a 16-bit sequence number, and a 32-bit timestamp. On the other hand, a Service Specific Convergence Sublayer (SSCS) specification, documented in ITU-T Recommendation I.366.2, provides a set of formats and procedures useful for conveying voice payloads over AAL2. The SSCS header format defines a 5-bit UUI codepoint to be partitioned, depending on the profile for that connection, between a payload type field and a sequence number. Of course, there exists many other examples of such protocols.

In the past, hardware design for VoIP has been specifically tailored to the protocol to be supported. This classical approach may have been adequate in the past, because one device supported one protocol. However, as stated earlier, with the growing emphasis on convergence, the devices are expected to handle multiple protocols, in principle converting from any VoIP encapsulation to any other. The present invention provides a meta-architecture, a design methodology, for multi-protocol VoIP handling. With this design approach, all of the redundancy among protocols has been captured and modularized, so that the vast majority of the hardware design can be reused from one implementation to another, saving much engineering effort.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### BRIEF SUMMARY OF THE INVENTION

In view of the aforementioned needs, the invention contemplates a modularized playback system comprising a generic playback engine coupled to a protocol specific module. These components are reusable for any real-time or VoIP protocol. Protocol specific plug-ins are used to convert and format the arriving task if necessary and extract any necessary information for the Playback Engine. Because the protocol specific module converts data packets to a predetermined format acceptable by the generic playback engine, the same playback engine may used with any protocol by switching to the appropriate protocol specific module.

The protocol specific module receives a packet. This module is comprised of two components, a preprocessor and a timestamp generator. The preprocessor parses and obtains any information required by the playback engine, such as a timestamp in the packet's native format. The timestamp generator generates a timestamp for the packet that is compatible with the generic playback engine.

The generic playback engine processes a packet with a predetermined timestamp. The generic playback engine comprises a timestamp to playback time translator and a comparator. The timestamp to playback time translator calculates a playback time for the packet. In calculating the playback time, the translator adds to the timestamp, an observed delay time and a jitter delay. The observed delay time is a combination of remote to local clock mapping and propagation delay. The jitter delay enables the playback engine is to accommodate packets arriving out of order or at an inconsistent rate. The comparator compares the playback time to the local time and plays back the packet at the appropriate time. Of course if the protocol being used is compatible with the generic playback engine, then a protocol specific module is not required.

By way of operation, a packet is received by the protocol specific module. The packet is parsed by the preprocessor. The packet is then forwarded to the timestamp generator which determines the packet's timestamp in the packet's original format and then generates a timestamp that is compatible with the generic playback engine. The packet with converted timestamp is then forwarded to the generic playback engine where it is processed by the timestamp to playback time translator. The translator then determines the playback time. In generating a playback time, the translator obtains the timestamp and adds a delay factor. The delay factor is comprised of two components, an observed delay and a jitter delay. The observed delay component is the sum of local to remote clocking mapping inconsistencies and propagation delay. Jitter delay, which is usually adjustable, enables the playback engine to accommodate packets that are received out of order or at an inconsistent rate. A comparator then holds the packet until the appropriate time and it is then played back.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE SEVERAL VIEWS OF THE DRAWING

The drawings illustrate the best mode presently contemplated of carrying out the invention.

FIG. 1 is a block drawing the system contemplated by the present invention coupled to a protocol specific plug-in;

FIG. 2 is a more detailed block diagram of the system of the present invention and the protocol specific plug-in shown in FIG. 1

FIG. 3 is a block diagram of the operation of the present invention.

### DETAILED DESCRIPTION OF INVENTION

The generic multi-protocol playback engine present invention contemplates a modularized system comprising a generic playback engine that is coupled to a protocol specific plug-in module when necessary. In the preferred embodiment, the engine and protocol specific plug-in module are developed in hardware, however as those skilled in the art can readily appreciate, the modular design of the present invention may be comprised of hardware, software, or a combination thereof.

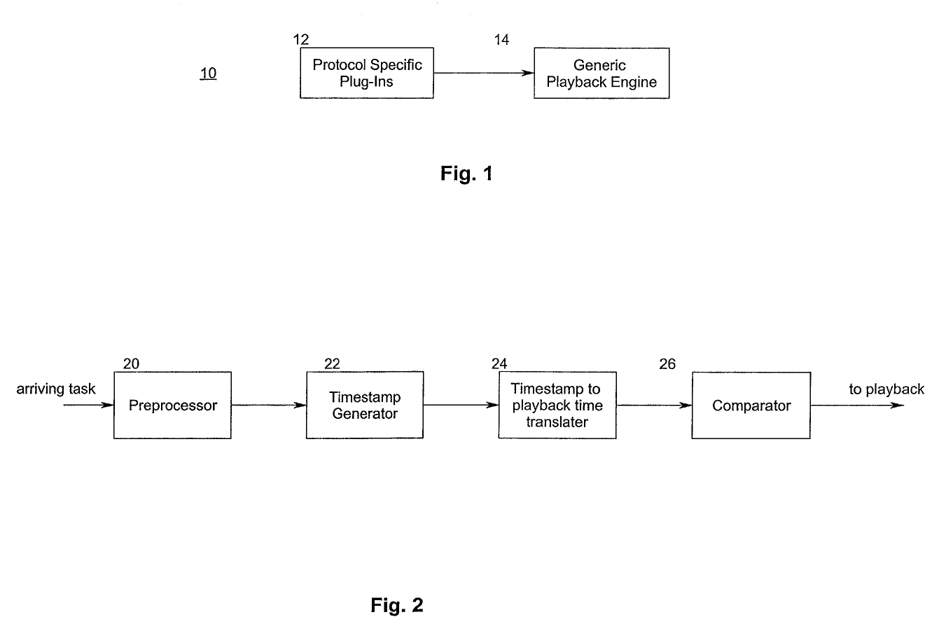

Referring to FIG. 1, there is shown a block diagram of an embodiment of the present invention, generally designated 10. An arriving task is processed by a protocol specific plugin 12 and is then forwarded to a generic playback engine 14. After the task is processed by the generic playback engine 14, the output may be sent to a playback device for output or to another component of the playback engine for futher processing. The present invention is primarily concerned with algorithms for VoIP, such as translating the timestamp to a playback time, and designs for implementing the algorithms such that reusable hardware devices may implemented which are protocol independent, not with the actual playing back of the task

In the preferred embodiment, the input to the Playback Engine 14 is a packet with a 32-bit timestamp, such as provided in RTP. If the protocol is something other than what the playback engine 14 is designed to accept, then a protocol-specific plug-in 12 must generate a timestamp from whatever is in the packet's header.

Referring to FIG. 2, there is shown a more detailed description of the present invention. The preprocessor 20 and timestamp generator 22 comprise the protocol specific plug-in module 12 while the timestamp to playback time translator 24 and the comparator 26 comprise the generic playback engine 14. It is contemplated that the functions of these components may be executed in hardware, software, or a combination thereof.

The operation of the playback engine of FIG. 2 will now be explained. A task (not shown), typically a received VoIP packet will arrive at the protocol specific plug-in module 12. The preprocessor 20 parses the packet and obtains any information needed by the playback engine 14 or the timestamp generator 22 such as the timestamp of the packet in its native format. The timestamp generator 22 then converts the timestamp from the packet's original format to a format compatible with the generic playback engine 14. The packet is then forwarded to the generic playback engine 14. The Translator 24 resolves the playback time of the task using the timestamp either explicitly provided in the packet header or implicitly generated from the information in the header. Preferably, the task will contain a 32-bit timestamp representing the time at which the first audio sample in the packet was generated from the analog source. The timestamp enables the approximately playback time to be extrapolated from the packet. In order to ensure that the audio does not sound distorted at the receiving end, the sampling time, tₛ, is mapped to the playback time, tₚ, wherein the mapping is a simple additive translation:

tₚ−tₛ+Δ.

In order to determine an appropriate value for Δ it should be noted that the mapping from timestamp to playback time is the sum of three components, the difference between the sender's and receiver's clocks, the propagation delay of the packets from sender to receiver, and jitter tolerance.

The first component in determining Δ is the remote-to-local clock mapping. The clocks on two different computers are typically not synchronized and thus each computer has its own time. However, the clock rate, for example 8 kHz, is usually negotiated once beforehand. Handshaking protocols for negotiating clock rates are well known in the art. In contrast, its much harder to negotiate the actual reading of the clock at any given time without a synchronous source available to both sides, for example a satellite (GPS). Therefore, in IP networks, it is typically accepted that both sides have clocks with a reasonably accurate clock rate, as per the negotiated frequency, but the value of any clock on the network is arbitrary at any given time. It should be noted that there are systems that negotiate clock rate every 125 micro seconds, but not the actual timestamp.

For example, the receiver's clock may read 192 while the sender's clock reads 901, thus the first component of the additive translation factor Δ, remote-to-local clock mapping, is computed by calculating the difference between the clocks, which in this example is 901−192=709.

The second factor in determining Δ is the propagation delay. Even if the clocks on the sending and receiving end were synchronized, it still takes some time for a packet to propagate from the sender to the receiver. This delay must also be a part of the additive translation factor Δ used in calculating the playback time from the sending timestamp.

The third factor in determining Δ is jitter tolerance. If only the remote to local clock mapping and propagation delay are used in calculating Δ, then the playback time would always equal the sampling time, calibrated for the remote-to-local clock difference, plus the delay required to transfer the packet from the sender to the receiver. While this approach would work if packets arrived at a constant rate, in practice, especially for IP networks, this is not always the case. Some packets may arrive faster than expected and in bursts while other packets may take a longer time to arrive. This variation in packet arrival rate is known as jitter. In order to compensate for jitter, a playback engine must buffer packets an amount of time sufficient to allow the orderly, regular playout of the packets. Therefore, in order to compensate for jitter, an additional playback delay is inserted, which must also be used in calculating Δ. Typically, acceptable jitter delay is usually between 128 and 256 milliseconds and is programmed into the system.

While these three factors theoretically comprise Δ, in practice the first two factors, remote-to-local clock mapping and propagation delay, are indistinguishable. The sum of the effects of the first two factors, the observed delay or do, can be determined by observation by subtracting the sampling time, for example the sender's timestamp, from the arrival time on the receiver's clock. This difference, d₀ embodies the sum of the effects of the remote-to-local clock mapping and the propagation delay. At the beginning of a call, the average value of the observed delays may be used for calculating a resulting mean do for that call. For example, the observed delay of the first four packets may be utilized to calculate d₀.

Jitter tolerance, d₁, is a programmable value for each call. Therefore, the value of Δ is determined by Δ=d₀+d₁.

After the Timestamp to Playback Time Translator 24 has processed the task, it is forwarded to the Compare playback time against current time sub-block 26. Logically, once a playback time has been assigned, the time is constantly monitored and compared against the current time. When they are equal, the packet or task is played back. A buffer is often used to actually implement this block.

As contemplated by the present invention, the generic playback engine 14 is designed once and then reused for any VoIP encapsulation protocol. In cutting edge convergent products, this reuse can even occur within the same product, since multiple VoIP protocols may be supported. In order to reuse a single instantiation of the generic playback engine 14, a protocol specific plug-in 12 for each protocol must be supplied for each protocol supported.

While the embodiments of FIGS. 1 and 2 show a one to one correlation between protocol specific plug-ins and playback engines, it is also contemplated that a plurality of protocol specific plug-ins may be coupled to a single playback engine. Multiplexing or other switching means may be used to select the appropriate protocol specific plug-in. For example the protocol specific plug-ins may be programmed to only produce an output when the received packet is recognized as being for the protocol specific plug-in.

Furthermore, it is also contemplated that the generic playback engine 14 of the present invention may also be designed so that it may operate without a protocol specific plug-in for a specific protocol. For example, if the generic playback engine 14 is designed to read RTP formatted packets, then when the playback engine is used for a device on an RTP compatible network, no protocol specific plug-in 12 is necessary. However, the protocol specific plug-in 12 is necessary for any non-RTP compatible network. In this embodiment, the protocol specific plug-in 12 would have to convert any received packets into an RTP compatible format with an RTP compatible time stamp.

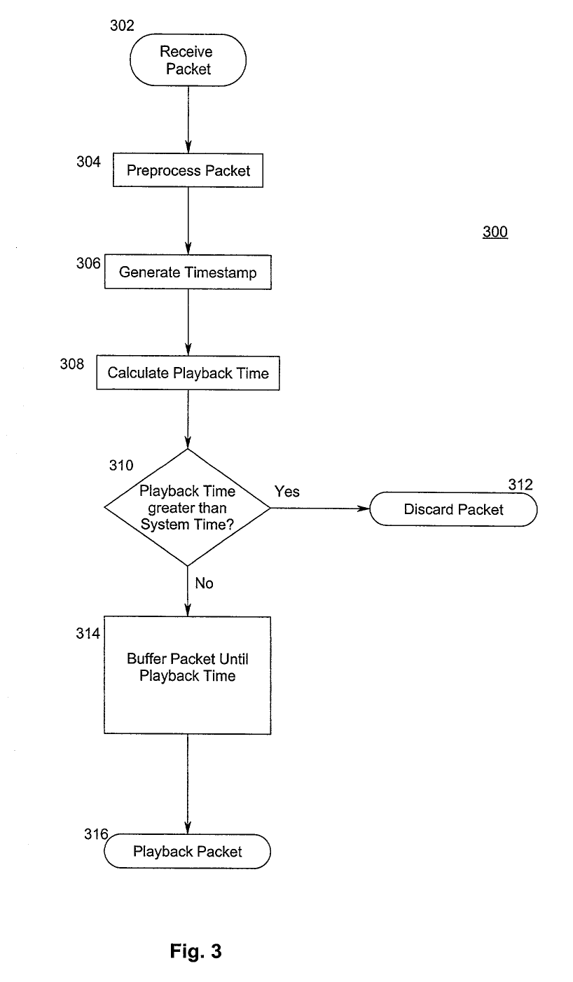

Referring now to FIG. 3 there is shown a method contemplated by the system of the present invention generally designated 300. At step 302 a packet is received. The packet would be received by the protocol specific plug in 12 from a receiver. At step 304 the preprocessor 20 processes the packet so that it is compatible with the generic playback engine 14. The preprocessing may include, but is not limited to, reformatting the header of the packet, extracting information such as the packet's timestamp in its original format, and obtaining reordering and re-timing data. At step 306 the packet is processed by the timestamp generator 22. The timestamp generator generates a timestamp such as an RTP like timestamp for use by the generic playback engine 14. The module 12 is protocol specific and converts the packet's timestamp to a format that is compatible with the generic playback engine 14.

At step 308, the packet is being processed by the timestamp to playback time translator 24 of the generic playback engine 14. The playback time is calculated by adding additive translation factor Δ to the packet's timestamp. As previously discussed, the additive translation factor Δ is comprised of three components, a remote to local clock mapping component, a propagation delay component, and a jitter tolerance component.

After calculating the playback time, at step 310 the playback time is compared to the system time. If the playback time is greater than the system time, then as shown at step 312 s the packet is discarded.

If the playback time is not greater than the system time in step 310, then processing continues at step 314. At step 314 the packet is buffered until the playback time whereupon at step 316 it is then sent to a playback device.

While the present invention has been described as converting the timestamp to RTP, those skilled in the art can readily appreciate that any timestamp that enables the playback engine to determine with certainty the playback time may be utilized.

Although the invention has been shown and described with respect to a certain preferred embodiment, it is obvious that equivalent alterations and modifications will occur to others skilled in the art upon the reading and understanding of this specification. The present invention includes all such equivalent alterations and modifications and is limited only by the scope of the following claims.

What is claimed is:

1. A method for receiving and playing packetized real-time data comprising:
providing a generic multi-protocol playback engine;
providing a protocol specific plug-in communicatively coupled to the multi-protocol playback engine;
receiving the packet by the plug-in, the packet having a timestamp, the plug-in parsing the header, and
converting the timestamp to a format readable by the playback engine;
translating the timestamp to a playback time; and
playing the packet at the playback time.

2. The method of claim 1 wherein the packet is a voice over IP packet.

3. The method of claim 1 wherein the format readable by the playback engine is RTP.

4. The method of claim 1, the translating step further comprises adding an observed delay to the timestamp, and adding a jitter delay to the timestamp.

5. The method of claim 4 wherein the observed delay is calculated by averaging delays observed from a plurality of packets.

6. A packet based real-time data receiver comprising:
a protocol specific plug-in, the plug in further comprising
a preprocessor having computer readable instructions stored on a computer readable medium thereon that receives a packet and parses the packet, and
a timestamp generating module comprising computer readable instructions stored on a computer readable medium thereon for generating a timestamp for the packet.

7. The packet based real-time data receiver of claim 6, further comprising:
a generic multi-protocol playback engine, the generic multi-protocol further engine comprising
a timestamp to playback time translator, the translator comprising computer readable instructions stored on a computer readable medium thereon for generating a playback time, and
a comparator, the comparator comprising computer readable instructions stored on a computer readable medium thereon that determines when the packet should be played back.

8. The packet based real-time data receiver of claim 7 wherein the timestamp is an RTP compliant timestamp.

9. The packet based real-time data receiver of claim 7 wherein the computer readable instructions for generating a playback time further comprise:
instructions for calculating an observed delay;
instructions for determining a jitter delay; and
instructions adding the observed delay and jitter delay to the timestamp.

10. A computer readable medium of instructions comprising:
a first computer readable medium, the first computer readable medium comprising:
means for receiving a packet; and
means for generating a timestamp for the packet.

11. The computer readable medium of instructions of claim 10, further comprising
a second computer readable medium of instructions, the second computer readable medium of instructions comprising
means for receiving the packet and timestamp from the first computer readable medium of instructions;
means for generating a playback time for the packet; and
means for processing the packet at the playback time.

12. The computer readable medium of instructions of claim 11 wherein the timestamp is RTP compliant.

13. The computer readable medium of instructions of claim 11 wherein the means for generating a playback time further comprises:
means for determining an observed delay;
means for determining a jitter delay; and
wherein the playback time is calculated by adding the observed delay and jitter delay to the timestamp.

14. The computer readable medium of instructions of claim 11 further comprising
means for comparing the playback time to current system time wherein the comparing means causes the packet to be processed at an appropriate time.

15. A packet based real-time receiver comprising
a protocol specific plug-in; and
a generic playback engine;
wherein the protocol specific plug-in is communicatively coupled to the generic playback engine; and
wherein the protocol specific plug-in receives a packet, converts the packet into a converted packet in a format readable by the generic playback engine, and sends the converted packet to the generic playback engine;
wherein the generic playback engine determines when the packet should be played back and plays the packet accordingly.

16. The packet based real-time receiver of claim 15 wherein the protocol specific plug-in further comprises a timestamp generator, wherein a timestamp compatable with the generic playback engine is sent to the generic playback engine with the converted packet.

17. The packet based real-time receiver of claim 16, the protocol specific plug-in further comprises a preprocessor, wherein the preprocessor receives the packet, converts the packet to the converted packet, and forwards the packet to the timestamp generator.

18. The packet based real-time receiver of claim 17, the generic playback engine further comprises a timestamp to playback time translator that calculates a playback time based on the timestamp.

19. The packet based real-time receiver of claim 18 wherein the timestamp to playback time translator calculates the playback time by adding an observed delay and a jitter delay to the timestamp.

20. The packet based real-time receiver of claim 19 wherein the generic playback engine further comprises a comparator that compares the playback time with current system time and causes the packet to be played at an appropriate time.

21. A generic multi-protocol Voice over IP playback engine, comprising:
a protocol specific plug-in module, the protocol specific plug-in module further comprising:
means for preprocessing a packet;
means for generating a timestamp from the preprocessed packet; and
a generic playback engine communicatively coupled to the plug-in module, the playback engine further comprising:
means for calculating a playback time; and
means for comparing the playback time with a time local to the receiver;
wherein the means for calculating playback times calculates the playback time by adding an observe delay and a pre-programmed jitter delay to the timestamp;
wherein the packet is played when the playback time is the same as the time local to the receiver; and
wherein the generic playback engine may be utilized with any protocol by switching to an appropriate protocol specific plug-in module.
